(19) United States
(12) Patent Application Publication
(10) Pub. No.: US 2005/0128946 A1
(43) Pub. Date: Jun. 16, 2005

(54) Network statistics information service system and internet access server

(76) Inventors: Yasuo Murakami, Fujisawa (JP); Mitsuhiro Wada, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 10/898,218

(22) Filed: Jul. 26, 2004

(30) Foreign Application Priority Data
Dec. 11, 2003 (JP) 2003-412812

(51) Int. Cl. H04L 12/26; H04L 12/28

(52) U.S. Cl. 370/230; 370/252; 370/254

(57) ABSTRACT

A network statistics information service system comprised of a service provider system having a database for storing statistics data and statistics information collection conditions for each user and an access server for receiving, upon the authentication of a user terminal, a response packet indicative of the result of authentication, a request source user ID, the statistics information collection conditions, and statistics parameters from the service provider system, wherein the access server collects statistics information for each user according to the statistics information collection conditions and the statistics parameters indicated by the response packet while the user terminal is connected to the Internet, and notifies the service provider system of updated statistics data, and the service provider system updates the database based on the data received from the access server and discloses at least a part of the statistics data accumulated in the database in response to a request from the user terminal.

### CLAIM OF PRIORITY

The present application claims priority from Japanese application serial No. P2003-412812, filed on Dec. 11, 2003, the content of which is hereby incorporated by reference into this application.

### BACKGROUND OF THE INVENTION

(1) Field of the Invention

The present invention relates to a network statistics information service system and to an Internet access server.

(2) Description of Related Art

Over an IP (Internet Protocol) network represented by the Internet, data is transferred in accordance with IP protocols. A communication agency providing an Internet access service for connecting a user terminal to the IP network is termed an Internet Service Provider (ISP). When an Internet user connects a user terminal to the Internet, a dial-up connection has previously been performed to an Internet service provider via the ISDN (Integrated Service Digital Network)/telephone line network. However, with the rapid prevalence of a broadband in recent years, it has become possible to access an Internet service provider via a high-speed access line network such as FTTH (Fiber To The Home), DSL (Digital Subscriber Line) Cable Internet, or a wireless system such as FWA (Fixed Wireless Access).

In a conventional Internet access using a telephone line, an Internet service provider has performed usage-based accounting for a user in accordance with the use time of the Internet. In a broadband environment, on the other hand, an Internet service provider has introduced a fixed-price accounting system which charges a fixed price to a user on a monthly basis, which is different from the conventional usage-based accounting system using a telephone line. The introduction of the fixed-price accounting system has spared Internet users the need to care about the charge and allowed user terminals to be regularly connected to the Internet.

An Internet service provider provides an Internet access service to users via an access server which accommodates various type of high-speed access lines mentioned above. In this case, PPP (Point-to-Point Protocol) has been used widely as a communication protocol between the access server and the user terminal. The PPP is a protocol originally proposed to provide a link such as TCP/IP on a serial line such as a telephone line or a dedicated line and has been standardized as Request for Comments (RFC) 1661 at the Internet Engineering Task Force (IETF).

The PPP is composed of an LCP (Link Control Protocol) operating in the data link layer of an OSI reference model and an NCP (Network Control Protocol) operating in a network layer. The LCP is literally a protocol for controlling a link which establishes a data link between two communication devices through a negotiating (compromising) operation concerning communication conditions such as a data size, the presence or absence of data compression, and a transmission speed and then performs a control operation for examining and releasing the data link. The NCP performs, after the establishment of a data link in accordance with the LCP, the selection of a higher-layer protocol for the network layer, the allocation/setting of a network address, and the like. The PPP has also been used widely in a broadband environment. For example, the PPPoE (PPP Over Ethernet) defined in the RFC 2516 has been known as a PPP protocol to be used on the Ethernet (Registered Trademark).

An Internet service provider stores information on users and statistics data as attribute values in a database, which is managed in a unified manner by an authentication server and an accounting server. The authentication server and the accounting server are normally communicative with an access server via an IP network. For communication between these servers, the RADIUS (Remote Authentication Dial In User Service) is used normally. Communication protocols concerning the RADIUS are defined as, e.g., the RFC 2865, the RFC 2866, and the RFC 2869.

The RADIUS has adopted a server client system which operates an authentication server and an accounting server as RADIUS servers and operates an access server as a RADIUS client, thereby implementing the transmission and reception of a user attribute value between these servers. Specifically, the access server having received an Internet access request from a user terminal transmits a user name and a password extracted from the access request to the authentication server in accordance with the RADIUS authentication protocol and thereby inquires the authentication server of whether or not the request source user terminal is an authorized subscribing user.

Upon receiving a response indicative of normal termination of user authentication from the authentication server, the access server permits the request source user terminal to access the Internet and establishes a PPP session with the user terminal. This allows the user terminal to access various servers on the Internet. The access server, which has permitted the user terminal to access the Internet, starts to collect accounting information (network statistics information) on the user terminal (user) and transmits the accounting information to the accounting server in accordance with the RADIUS accounting protocol. The accounting server identifies individual terminal users by user names and accumulates and manages the accounting information for each user.

A network management system which collects statistics monitor information including the foregoing accounting information on a per communication-flow basis is disclosed in, e.g., Japanese Laid-Open Patent Publication No. 2001-257722.

At present, the accounting information managed by the Internet service provider at the accounting server includes, e.g., the Internet session time, the number of transmission/reception packets, and an amount of transmitted/received data for each user. In a regular connection service using a fixed-price accounting system, the accounting information is used only by the Internet service provider to recognize the use situation of the network and as feed back information in the design of a next-generation network.

This is because a majority of current Internet access services assume a communication service of best-effort type which does its best effort but offers no guarantee of packet transfer. Accordingly, even when temporary packet loss is caused by congestion on the network while an Internet access service is provided, e.g., the Internet service provider is not obliged to report the occurrence of the packet loss and the number of loss packets to each of the users.

As competition between Internet access services has heated up in recent years, there have been an increasing number of cases where Internet service providers introduce an SLA (Service Level Agreement: Service Quality Assurance System) for differentiation from services offered by other providers. An SLA service indicates a contract of providing a communication service which guarantees a given level of communication quality and is an Internet access service provided under a detailed contract made on a per user basis such that, if the communication quality becomes lower than the preliminarily guaranteed level, e.g., a deposit is paid to the user. Specific examples of a contract menu for an SLA service includes one which guarantees, if an abnormality is found in a communication service, the notification of a user of service interruption within a prescribed period or a given period or given percentage [%] of service time increase.

To provide an SLA service to users, it is insufficient for an Internet service provider only to manage statistics information including an Internet session time and the number of transmitted/received packets such as conventional accounting information. It becomes necessary for the Internet service provider to have the function of collecting statistics information more detailed than collected conventionally and managing the collected information as new network use information for each user.

As broadband access has become prevalent and regular connection to the Internet has become constant, some of Internet users who used to receive contents information from Web servers have been changing to information transmitters possessing Web servers of their own. In such an environment, an Internet user needs information indicating an access situation from the Internet to his terminal, e.g., a Web server constructed by the user, as new statistics information. Even if the user attempts to individually collect and manage access information to his terminal, however, he encounters difficulty in actually performing the individual collection and management of the access information since it is predicated on high-level skills related to network operation and the installation of a dedicated network monitoring system.

### SUMMARY OF THE INVENTION

An object of the present invention is to provide a network statistics information service system and an access server for performing automatic collection and management of statistics information desired by an Internet user to disclose the statistics information to the user.

Another object of the present invention is to provide a network statistics information service system and an access server capable of notifying an Internet user of statistics information required by the user by expanding the function of an existing accounting system.

To attain the foregoing objects, a network statistics information service system according to the present invention is composed of: a service provider system having a database for storing, in correspondence with a user identifier, statistics data and conditions for collecting statistics information desired by a user; and an access server for transmitting an authentication request packet to the service provider system upon receiving an authentication request from a user terminal via an access network, receiving from the service provider system a response packet indicating a result of authentication, an identifier of the request source user, the statistics information collection conditions, and statistic parameters to be collected, and responding to the user terminal based on the result of authentication indicated by the response packet, wherein the access server is comprises of: a management table for storing the statistics information collection conditions and the statistics parameters each indicated by the response packet from the service provider system in correspondence with the user identifier and a session identifier; statistics data updating means for collecting information in accordance with the statistics information collection conditions and the statistics parameters each indicated by the management table while the user terminal is connected to the Internet and updating statistics data in the management table; and update request generating means for generating an update request packet indicating the updated statistics data and transmitting the generated update request packet to the service provider system, and the service provider system updates the statistics data in the database based on contents of the update request packet received from the access server and discloses, in response to the request from the user terminal, at least a part of the statistics data accumulated in the database in correspondence with the user identifier of the user terminal.

More specifically, the update request generating means provided in the access server transmits, to the service provider system, e.g., the update request packets periodically generated at specified intervals while the user terminal is connected to the Internet and the update request packet generated upon release of a session with the user terminal resulting from termination of the connection to the Internet. On the other hand, the service provider system is comprised of: a statistics information management server (accounting server) for managing the database and responding to the authentication request packet and the update request packet from the access server; and a Web server for executing a process for disclosing the statistics data in response to the request from the user terminal.

In the network statistics information service system according to the present invention, the update request generating means of the access server generates, e.g., upon occurrence of a specified event preliminarily specified by the statistics information collection conditions, an update request packet indicative of the occurrence of the specified event and transmits the generated update request packet to the service provider system.

Specifically, in an embodiment of the present invention, one of said statistics information collection conditions specifies a monitored IP address and a threshold and the statistics data updating means counts the number of packets transmitted from the monitored IP address and, when said number of packets becomes equal to or more than the threshold, the update request generating means generates the update request packet indicative of the number of packets equal to or more than the threshold and transmits the generated update request packet to the service provider system.

In another embodiment of the present invention, one of the statistics information collection conditions specifies counting of the number of loss packets, the statistics data updating means counts the number of packets lost upon occurrence of network congestion, and the update request generating means generates an update request packet indicative of said number of loss packets upon recovery from the congestion and transmits the generated update request packet to the service provider system.

In still another embodiment of the present invention, one of said statistics information collection conditions specifies counting of a service interruption time, the statistics data updating means counts the service interruption time resulting from network congestion, and the update request generating means generates an update request packet indicative of the service interruption time upon recovery from the congestion and transmits the generated update request packet to the service provider system.

One characteristic feature of the present invention is such that the service provider system has, in addition to the foregoing statistics information management server and Web server, a mail server for notifying, upon receiving the update request packet resulting from occurrence of a specified event from the access server, a corresponding user terminal of the occurrence of the specified event.

An Internet access server according to the present invention has the function of transmitting an authorization request packet to a service provider system upon receiving an authorization request from a user terminal and responding to the user terminal, upon receiving from the service provider system a response packet indicating a result of authentication, an identifier of the request source user, statistics information collection conditions and statistics parameters to be collected, based on the result of authentication indicated by the response packet. The Internet access server comprising of: a management table for storing the statistics information collection conditions and the statistics parameters each indicated by the response packet received from the service provider system in correspondence with the user identifier and a session identifier; statistics data updating means for collecting information in accordance with the statistics information collection conditions and the statistics parameters each indicated by the management table while the user terminal is connected to the Internet and updating statistics data in the management table; and update request generating means for generating an update request packet indicative of the updated statistics data and transmitting the generated update request packet to the service provider system.

The statistics information collection conditions and statistics parameters are communicated between the access server and the service provider system by using, e.g., an attribute in accordance with the RADIUS protocol.

The present invention allows collection of statistics information including packet loss and a service interruption time for each of user terminals connected to the Internet in accordance with statistics information collection conditions preliminarily specified such that the collected information is disclosed to the user. Accordingly, it becomes possible to provide an Internet access service and a network statistics information service under a detailed contract made on a per user basis.

### BRIEF DESCRIPTION OF THE DRAWINGS

FIG. 1 is a network configuration diagram including a network statistics information service system according to the present invention;

FIG. 2 is a view showing an example of a main signal transfer protocol stack used in the network of FIG. 1;

FIG. 3 is a view showing an example of a control signal transfer protocol stack used in the network of FIG. 1;

FIG. 4 is a block diagram showing in detail the hardware 4 of the access server shown in FIG. 1;

FIG. 5 is a block diagram showing in detail the control processing unit 44 in the access server 4 of FIG. 4;

FIG. 6 is a sequence diagram showing the operation of the network statistics information service system according to the present invention;

FIG. 7 is a sequence diagram showing detailed operations in Steps S04 to S06 in FIG. 6;

FIG. 8 is a sequence diagram showing in detail Step S10 for updating network statistic information in FIG. 6 and a network statistics information referencing operation performed by a user terminal;

FIGS. 9A and 9B are views each showing an example of an accounting management database provided in the authentication/accounting server 21;

FIG. 10 is a view showing the format of an access accept packet transmitted from the authentication/accounting server 21 to the access server 4 in FIG. 1;

FIG. 11 is a view for illustrating the contents of a Vender Specific attribute exchanged between the authentication/accounting server 21 and the access server 4 in FIG. 1;

FIG. 12 is a view showing an example of the PPP user management table 56 of FIG. 5;

FIG. 13 is a view showing the format of an accounting request (start) packet transmitted from the access server 4 to the authentication/accounting server 21 in FIG. 1;

FIG. 14 is a view showing the format of an accounting request (interim-update) packet transmitted from the access server 4 to the authentication/accounting server 21 in FIG. 1;

FIG. 15 is a view showing the format of an accounting request (stop) packet transmitted from the access server 4 to the authentication/accounting server 21 in FIG. 1;

FIG. 16 is a sequence diagram showing an operation of the network statistics information service system according to the present invention when network congestion is detected; and

FIG. 17 is a sequence diagram showing an operation of the network statistics information service system according to the present invention when a monitored packet threshold is exceeded.

### DESCRIPTION OF THE PREFERRED EMBODIMENTS

Referring to the drawings, an embodiment of a network statistics information service system according to the present invention will be described herein below.

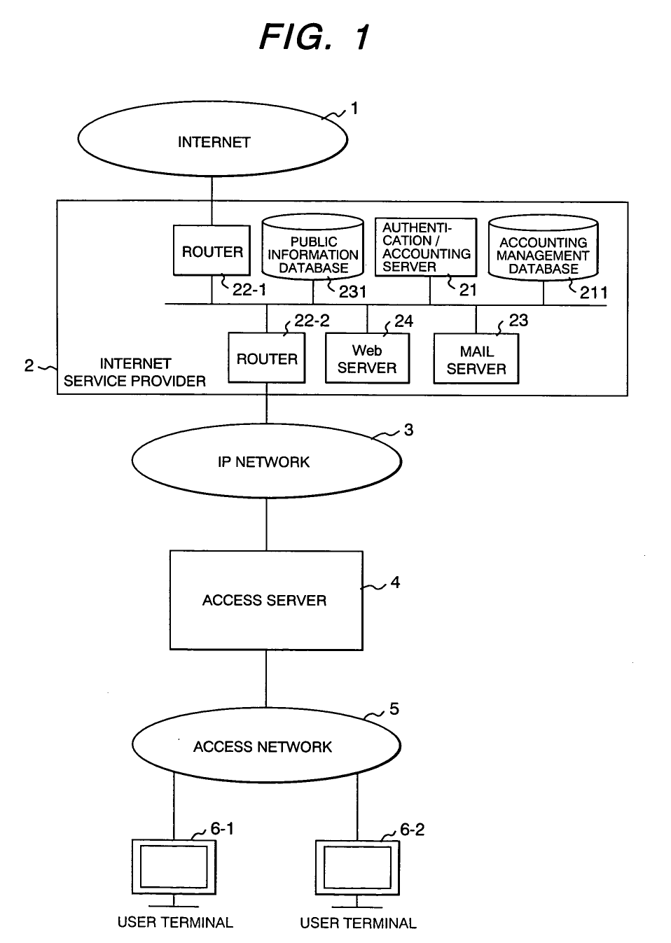

FIG. 1 is a network configuration diagram including the network statistics information service system according to the present invention.

In FIG. 1, an access server 4 is communicative with an authentication server and a statistics information management server (hereinafter referred to as an accounting server) each composing an Internet service provider 2 via an IP network 3. Although the authentication server and the accounting server are shown here as a single server (authentication/accounting server) 21, it may also be separated into two servers. Besides the authentication/accounting server 21, the Internet service provider 2 has a router 22-1 for connection with the Internet 1, a router 22-2 for connection with the IP network 3, a mail server 23, and a Web server 24. A reference numeral 211 denotes an accounting management database managed by the authentication/accounting server. A reference numeral 231 denotes a database for accumulating the mail addresses of Internet users and statistics data as public information to the users, which is used by the mail server 23 and the Web server 24.

Each of user terminals 6 (6-1 and 6-2) is the terminal of a user belonging to the Internet service provider 2. Upon access to the Internet 1, the user terminal 6 transmits an access request to the access server 4 via an access network 5. Between the user terminal 6 and the access server 4, the PPP is used as a protocol for the establishment of a link to be used by the user terminal, user authentication, and the allocation of an IP address. As the access network 5, e.g., a telephone switching network or a broadband access network such as ADSL or FTTH is used.

The Web server 24 is a server accessible from the user terminal and provides public network statistics data (parameter information) accumulated in the database 231 to Internet users. Each of the Internet users is allowed to acquire his latest parameter information by accessing the Web server 24 using the user terminal 6. The mail server 23 manages the mail address of each of the Internet users and notifies the user of statistics data by electronic mail upon the occurrence of a specified event or in response to a request from the user, which will be described later.

FIG. 2 shows an example of a main signal transfer protocol stack necessary for communication between each of the user terminals 6 (6-1 and 6-2) and a target server on the Internet 1 via the access server 4 in the network statistics information service system shown in FIG. 1.

Since the user terminals 6 and the access server 4 are connected in accordance with the PPP, the PPP exists in each of the protocol stack 601 of the user terminal 6 and the protocol stack 401 of the access server 4. A protocol stack in a layer lower in order than the PPP differs depending on the type of a link layer on the access network 5. By way of example, a protocol stack when the lower-order layer is an Ethernet (registered trademark) network is shown in FIG. 2. Data is transferred from the access server to the target server in accordance with IP protocols (IPv4/IPv6), as shown in the protocol stacks 402 and 101.

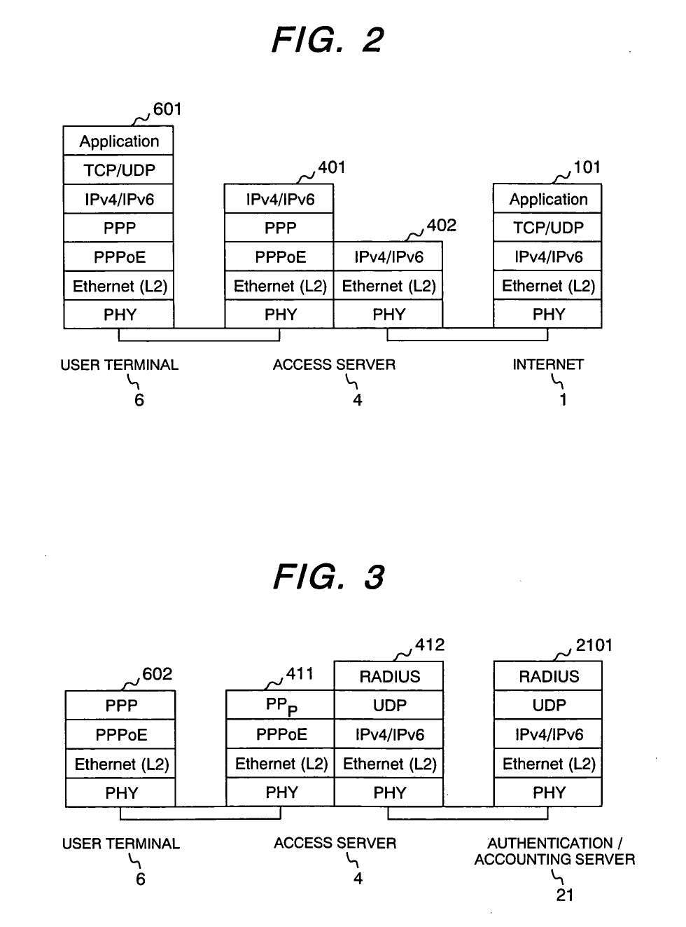

FIG. 3 shows an example of a control transfer protocol necessary for the communication of control information such as user authentication information, statistics information collection conditions, and statistics parameters to be collected.

As shown in the protocol stacks 602 and 411, the control information is communicated between the user terminal 6 and the access server 4 in accordance with the PPP protocol. On the other hand, the authentication information and the network statistics information are communicated between the access server 4 and the authentication/accounting server 21 in accordance with the RADIUS protocol, as shown in protocol stacks 412 and 2101.

In the RADIUS protocol, a RADIUS attribute (attribute value) is defined, which will be described later. The access server 4 and the authentication/accounting server 21 can communicate the control information necessary for processing the network statistics information such as the authentication information, the statistics information collection conditions, statistics-system parameters, and statistics data therebetween by imparting required attributes to the data portion (payload portion) of each of packets.

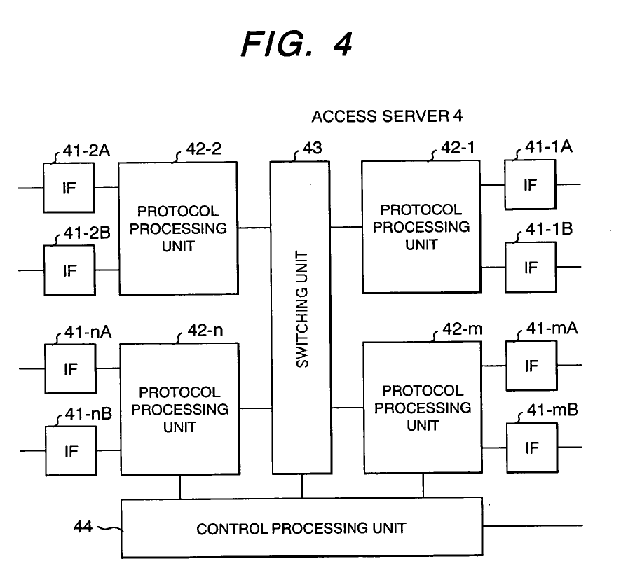

FIG. 4 is a block diagram showing an example of the hardware configuration of the access server 4.

The access server 4 is comprised of a control processing unit 44 for controlling the entire server, a switch (SW) unit 32 for outputting a packet to a specified line, a plurality of protocol processing units 42 (42-1 to 42-n) for processing a data link layer and an IP protocol as a higher-order layer, and a plurality of line interfaces (IF) 41 (41-1A to 41-nB) each having the function of terminating a physical layer in accordance with the type of a connection line thereof. Here, the line interfaces 41-1A, 41-2A, . . . and 41-nA indicate interfaces for input lines, while the line interfaces 41-1B, 41-2B, . . . and 41-nB indicate interfaces for output lines.

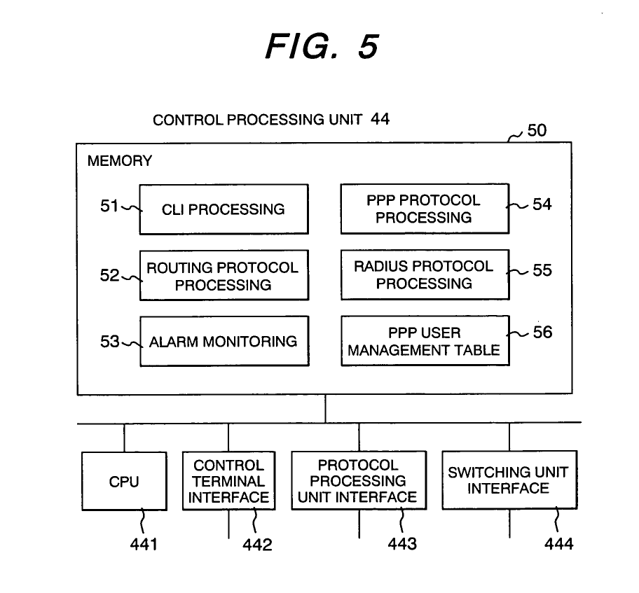

FIG. 5 is a block diagram showing an example of the control processing unit 44.

The control processing unit 44 is comprised of a data processor (CPU) 441, a memory 50, a protocol processing unit interface (IF) 443 for communication with the protocol processing unit 42, a switching unit interface 444 for communication with a switching unit 43, and a control terminal interface 442 for communication with a control terminal disposed outside. The CPU 441 executes various programs prepared in the memory 50.

The memory 50 stores therein programs related to the present invention such as, e.g., a CLI (Command Line Interface) processing routine 51, a routing protocol processing routine 52, an alarm monitoring processing routine 53, a PPP protocol processing routine 54, and a RADIUS protocol processing routine 55. In the memory 50, a PPP user management table 56 to be referenced for individual collection of statistics information for each Internet-user has been formed.

The CLI processing routine 51 is a program for processing a control command inputted by a system administrator from a control terminal (not shown) to control the access server 4. The routing protocol processing routine 52 is a program for processing routing information required to transfer a packet inputted from each of the line interfaces 41 to the access server 41 to one of the other line interfaces 41 corresponding to a destination address.

The routing information specified by the system administrator is set to a routing table (not shown) provided in each of the protocol processing units 42 in accordance with the routing protocol processing routine 52. A packet received by each of the input line interfaces 41-1A (i=1 to n) from the network is imparted with, e.g., an additional internal header including the routing information corresponding to the destination address of a packet header in the protocol processing unit 42-i and then transferred to the switching unit 43. The switching unit 43 transfers the input packet from each of the protocol processing units 42 to any one of the other protocol processing units in accordance with the routing information indicated by the internal header. Each of the protocol processing units 42-j (j=1 to n) removes the internal header from the packet received from the switching unit 43 and outputs the packet to the output line interface 41-jB.

The alarm monitoring processing routine 53 is a program for monitoring an alarm signal generated in the access server 4 and performing an operation responding to the alarm signal. The PPP protocol processing routine 54 for processing a PPP protocol signal is a program for executing a PPP termination process, an LCP process, an authentication process such as the PAP (Password Authentication Protocol) or CHAP (Challenge Handshake Authentication Protocol), and an NCP process such as the IPCP (Internet Protocol Control Protocol) in conjunction with the protocol processing unit 42 and in accordance with an RFC related to the PPP such as the RFC 1332, the RFC 1661, or the RFC 1994.

The RADIUS protocol processing routine 55 handles each of the RADIUS protocols including the RFC 2138, the RFC 2139, the RFC 2865, the RFC 2866, and the RFC 3162 and transfers information such as a user ID and a password to the authentication/accounting server 21 in conjunction with the PPP protocol processing routine 54 upon PPP authentication.

If the user authentication is successful, the authentication/accounting server 21 notifies the access server 4 of, e.g., network setting conditions such as an IP address to be used by the user and conditions for collecting statistics information such as the presence or absence of the notification of the number of loss packets, which will be described later, as attribute information on the authenticated user. The access server 4 stores the attribute information on each of the users received from the authentication/accounting server 21 in the PPP user management table 56 till a PPP session is released.

When the user terminal 6 having succeeded in authentication establishes a PPP session with the access server 5, the access server starts a statistics information collecting process. The access server 4 collects statistic information shown by various parameters such as, e.g., a session time, an amount of packet communication, and the number of loss packets based on the statistics information collection conditions shown by the PPP user management table 56. In order to collect the statistics information on a per PPP-session basis, the present embodiment registers a plurality of entries for managing statistics data (parameter information) corresponding to user identifiers and session identifiers in the PPP user management table 56.

On recognizing the establishment of the session with the PPP user, the access server 4 generates an accounting (statistics information collection) process start request packet in accordance with the RADIUS protocol processing routine 55 and transmits the generated packet to the authentication/accounting server 21. When the session with the PPP user is released, the access server 4 generates an accounting process end request packet in accordance with the RADIUS protocol processing routine 55 and transmits the generated packet to the authentication/accounting server 21.

The access server 4 collects, while the PPP session is sustained, the statistics information preliminarily specified with parameters by the Internet user, based on the statistic information collection conditions shown by the PPP user management table 56. The access server 4 generates an accounting process interim packet indicative of the collected statistics information periodically or in response to an event such as the occurrence of or recovery from congestion or a fault on the network and transmits the generated packet to the authentication/accounting server 21 in accordance with the RADIUS protocol processing routine 55.

The details of the accounting process start request packet, the accounting process end request packet, and the accounting process interim packet each transmitted from the access server 4 to the authentication/accounting server 21 and a communication procedure between the access server 4 and the authentication/accounting server 21 will become apparent from the following description.

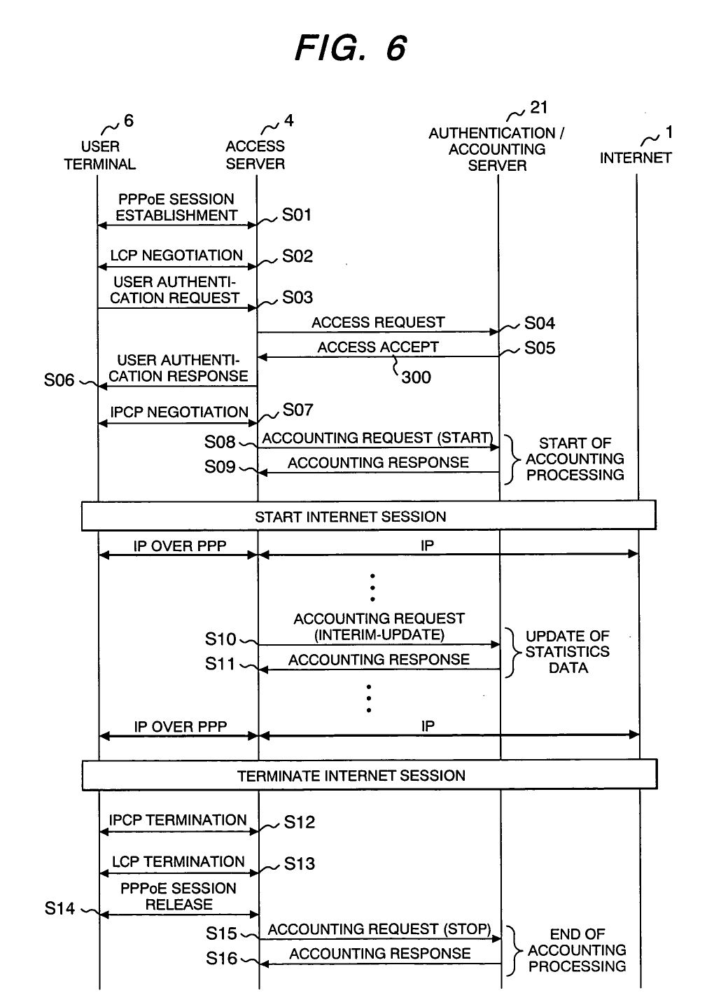

FIGS. 6 to 8 show a communication sequence when the user terminal 6 receives an Internet access service from the access server 4. However, the sequence diagrams illustrated here only show primary protocol messages in the present invention for the sake of clarity and do not precisely show all the messages exchanged between the user terminal and the access server and between the access server and the authentication/accounting server in actual applications.

As shown in FIG. 6, the user terminal 6 of the Internet user executes a PPPoE initialization process (S01) shown in the RFC 2516 with the access server 4. This process becomes necessary to identify a PPP frame multiplexed on the Ethernet particularly when the access network 5 is composed of an FTTH network. In the access server 4, the protocol processing units 42-1 to 42-n, e.g., execute the PPPoE initialization process.

When a PPPoE session is established through the PPPoE initialization process, the control processing unit 44 of the access server 4 executes PPP protocol signal processing in accordance with the PPP protocol processing routine 54. When the PPPoE session is established (S01), the control processing unit 44 sets up a link layer by the Link Control Protocol (LCP) process (S2) and transmits a user authentication request to the authentication/accounting server 21 in accordance with, e.g., the Challenge handshake Authentication Protocol (CHAP) shown in the RFC 1994 in response to the user authentication request (S03) from the user terminal 6.

In the present embodiment, the control processing unit 44 executes the RADIUS protocol processing routine 55 upon sending the user authentication request to the authentication/accounting server 21 and transmits an access request packet indicative of a user ID, a password, and the like to the authentication/accounting server 21 in accordance with the RADIUS protocol shown in the RFC 2865 or the like (S04). The authentication/accounting server 21 having received the access request packet judges whether the user of the authentication request source terminal 6 is an authorized user preliminarily registered.

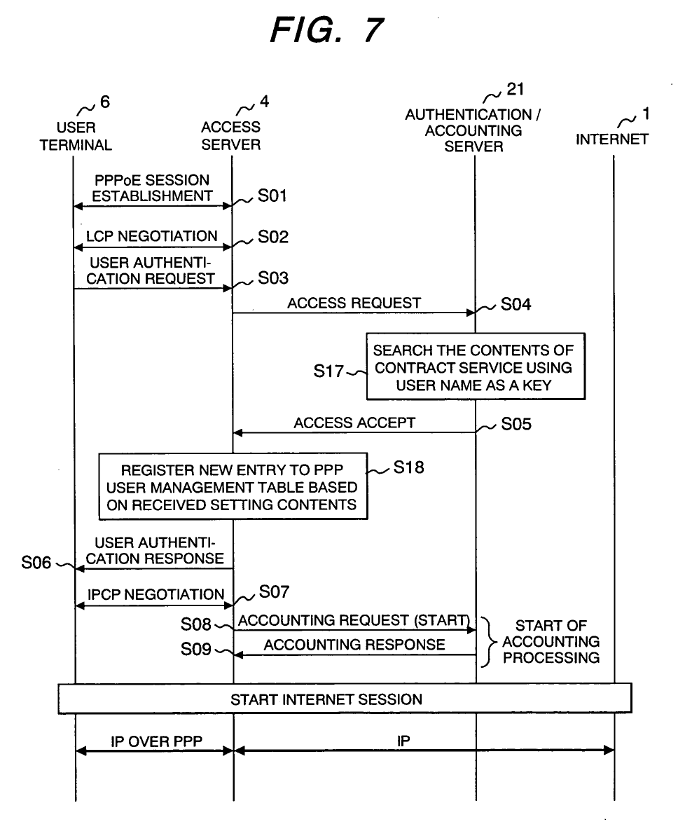

As shown in FIG. 7, the authentication/accounting server 21 having received the access request packet searches the accounting management database (DB) 211 for the contents of a service contracted with a request source user by using the user name indicated in the received packet as a key (S17) and returns an access accept packet 300 indicative of the result of authentication and the contents of the contracted service to the access server 4 (S05).

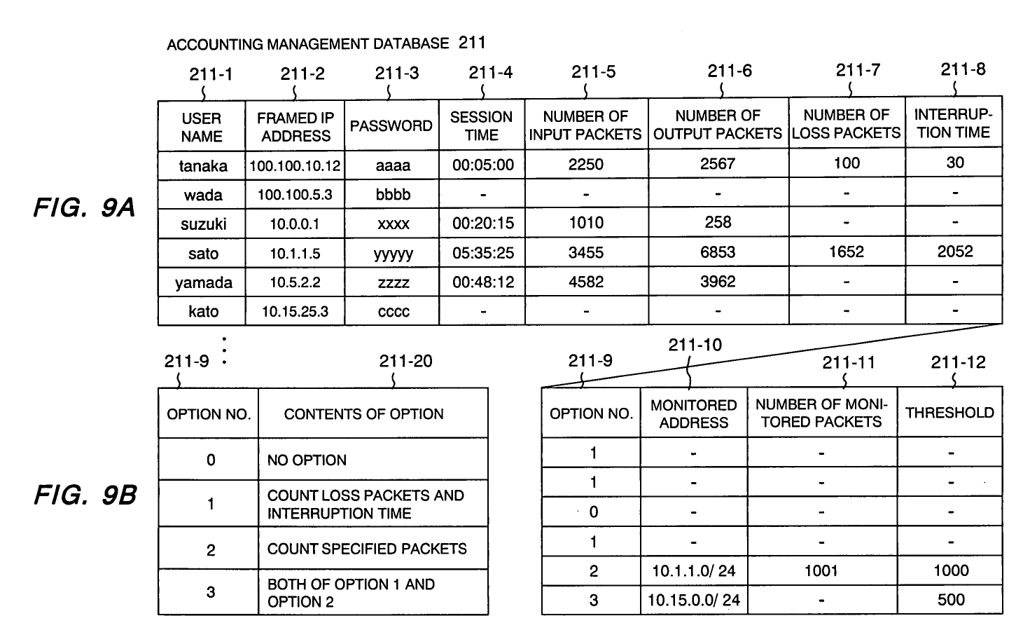

As shown in, e.g., FIG. 9A, the accounting management database 211 shows, in correspondence with a user name 211-1, a framed IP address 211-2, a password 211-3, a session time 211-4, the number of input packets 211-5, the number of output packets 211-6, the number of loss packets 211-7, an interruption time 211-8, an option number 211-9, a monitored address 211-10 indicative of a transmitter of a packet to be monitored, the number of monitored packets 211-11 corresponding to the monitored address, and a threshold 211-12. Although the accounting management database 211 actually contains other items of information necessary for accounting management such as the address of the user, the type of an Internet access contract, a charged amount, and an account for payment, these items of information are not shown in the drawings because they are not directly relevant to the present invention.

As shown in, e.g., FIG. 9B, the option number 211-9 preliminarily specifies, as the contents of an option 211-20, the contents of a data collection service (contracted service) to be executed by the access server 4. In the case where the user name of the access request packet is, e.g., “tanaka”, the authentication/accounting server 21 judges whether the request source user is an authorized user or not depending on whether the password indicated by the access request packet coincides with the password “aaaa” registered under the user name “tanaka” in the accounting management database 211. If the password coincides, the IP address 211-2 (“100.100.10.12”) to be allocated to the request source user terminal and the option number 211-9 (“1”) are acquired from the entry of the user name “tanaka”.

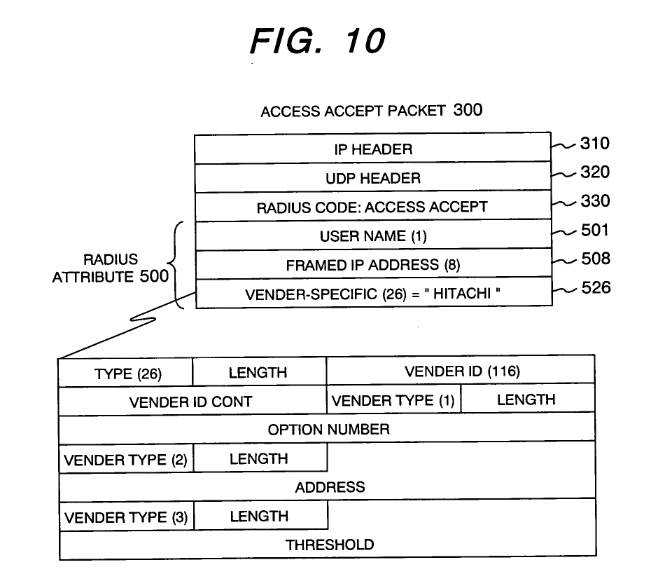

When the user authentication is successful, the authentication/accounting server 21 returns an access accept packet 300, which is shown in FIG. 10, to the access server 4 (S05). The user framed IP address and the option number specifying the contents of the contracted service which are acquired from the accounting management database 211 have been set to the access accept packet 300.

FIG. 10 shows an example of the format of the access accept packet 300. In the access accept packet 300 according to the present embodiment, the payload portion of the IP packet having an IP header 310 and a UDP header 320 contains a Radius Code 330 indicating that this packet is an access accept packet and a Radius attribute 500.

The Radius attribute 500 includes a User-Name attribute 501 indicative of the user name serving as the identifier of the user terminal, a Framed-IP-Address attribute 508 indicative of the IP address allocated to the user terminal, and a Vendor-Specific attribute 526.

In the Radius attribute shown in FIG. 10, the number enclosed in the parentheses at the end of each attribute represents an attribute number defined in the protocol. For example, the User-Name attribute 501 is described by the combination of the attribute number “1”, the subsequent data length, and the user name. The Vendor-Specific attribute 526 is used to implement a special function that cannot be specified by a normal attribute having the attribute number defined in the protocol.

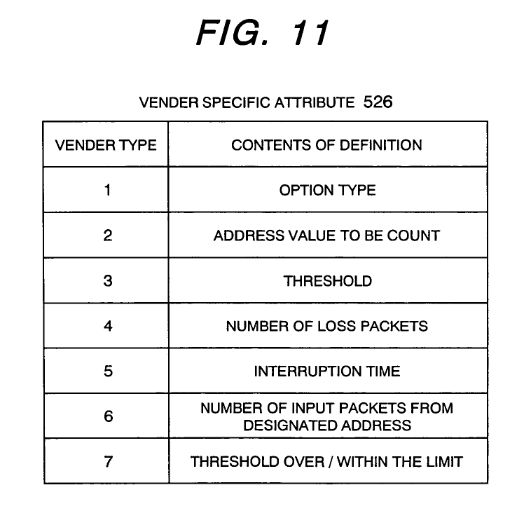

FIG. 11 shows a relationship between a Vender Type used as the Vender-Specific attribute 526 in the present embodiment and the contents of the definition. In the example shown here, seven Vender Types “1” to “7” are prepared and attributes such as the type of an option and the type of a parameter are preliminarily defined for each of the Vendor Types. In the case of the access accept packet 300 with the user name “tanaka” described above, the access server 4 is instructed to execute an information collection service shown by parameters (the number of loss packets and the interruption time) defined in the option number “1” for the terminal with the user name “tanaka” by specifying Vender Type (1) “1” in the Vender-Specific attribute 526.

The access server 4 that has received the access accept packet 300 from the authentication/accounting server 21 analyzes the attributes of the received packet and registers a new entry indicative of statistics information collection conditions and statistics data in the PPP user management table 56 in correspondence with the identifier of a request source user (S18).

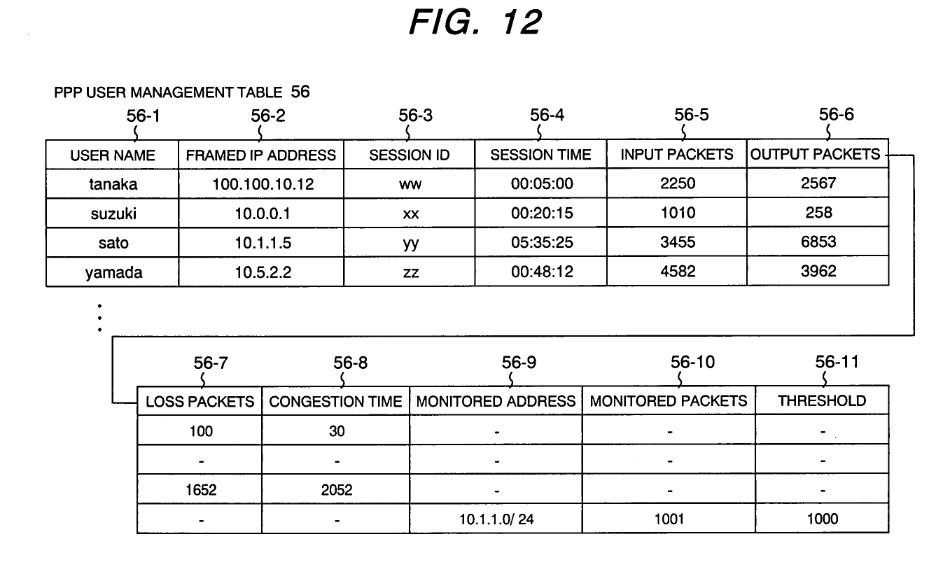

FIG. 12 shows an example of information registered in the PPP user management table 56.

Each of the entries of the PPP user management table 56 includes a User Name 56-1, a Framed IP Address 56-2 indicative of an allocated IP address, a Session ID 56-3 for uniquely identifying a currently sustained PPP session in the access server 4, a Session Time 56-4 indicative of the time duration of the PPP session, Input Packets 56-5 indicative of the number of input data packets in the PPP session, Output Packets 56-6 indicative of the number of output data packets, Loss Packets 45-7 indicative of the number of loss packets, Congestion Time 56-8 indicative of a service interruption time due to packet loss, Monitored Address 56-9 indicative of the address (monitored address) of a transmitter of a packet to be monitored, Monitored Packets 56-10 indicative of the number of monitored packets corresponding to the monitored address, and a Threshold 56-11.

In the case where the user name is “tanaka” described above, upon receiving the first access accept packet 300, an entry in which User Name 56-1=“tanaka”, Framed IP Address 56-2=“100.100.100.12”, Session ID 56-3=“ww”, Session Time 56-4 “00:00:00”, Input Packets 56-5=“0”, Output Packets 56-6=“0”, Loss Packets 45-7=“0”, Congestion Time 56-8=“0” are satisfied is registered in the PPP user management table 56.

When the entry registration in the PPP user management table 56 is completed (S18), the access server 4 transmits a user authentication response (S06) to the request source user terminal 6. Upon receiving the user authentication response, the user terminal 6 executes a communication procedure for setting an IP layer between itself and the access server 4 in accordance with the IPCP (IP Control Protocol) shown in the RFC 1332 (S07). When the setting of the IP address to the user terminal 6 and the setting of a PPP session by protocol signal processing are completed, the user terminal 6 is allowed to access the Internet 1.

When the setting of the PPP session with the user terminal 6 is completed, the access server 4 starts an accounting (statistics information collecting) process. At this time, according to the present invention, the control processing unit 44 of the access server 4 executes the RADIUS protocol processing routine 55, creates an accounting request (start) packet 301 as an accounting process start request packet based on the new entry information added to the PPP user management table 56, and transmits the generated packet to the authentication/accounting server 21 (S08).

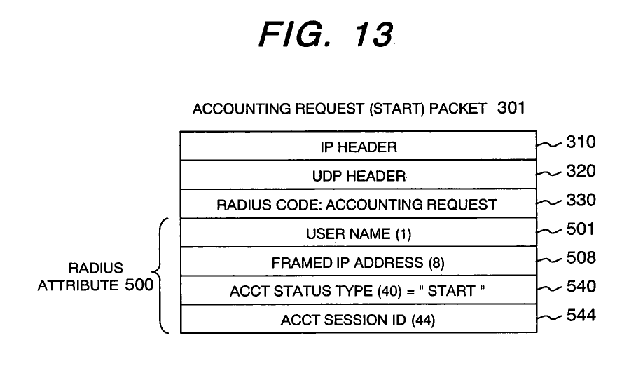

FIG. 13 shows the format of the accounting request (start) packet 301.

The accounting request (start) packet 301 includes, as the Radius attribute 500, the User-Name attribute 501 indicative of the user name, the Framed-IP-Address attribute 508 indicative of the IP address allocated to the user terminal, an Acct-Status-Type attribute 540 indicative of the type of an accounting process request packet, and an Acct-Session-ID attribute 544 indicative of a PPP session identifier between the user terminal and the access server. The Acct-Status-Type attribute 540 indicates whether the accounting request is an accounting process start request, an accounting process end request, or an interim accounting request. In the packet 301, a code “1” indicative of the accounting process start request (“start”) has been set.

In the example in which the user name is “tanaka”, User-Name attribute 501=“tanaka”, Framed-IP-Address attribute 508=“100.100.100.12”, Acct-Session-ID attribute 544=“ww” are set to the Radius attribute 500.

Upon receiving the accounting request (start) packet 301 from the access server 4, the authentication/accounting server 21 returns a response packet (accounting response) (S09) and starts the operation of collecting statistics information on an Internet user having the user name specified by the received packet.

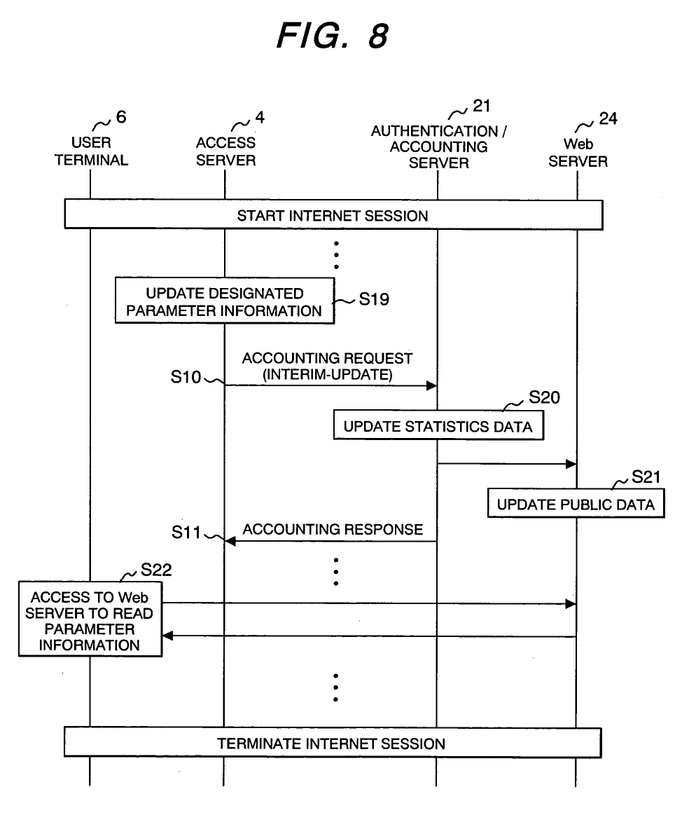

Referring to FIG. 8, a description will be given next to the operation of the accounting (statistics information collecting) process executed while the user terminal 6 is connected to the Internet.

While the user terminal 6 is connected to the Internet 1, the access server 4 collects, based on the entry information registered in the PPP user management table 56 in Step S18 of FIG. 7, statistics information indicated by parameters such as, e.g., the numbers of input/output packets and the number of loss packets for each user-terminal and periodically updates the PPP user management table 56 (S19). Every time the PPP user management table 56 is updated, an elapsed time from the previous updating time is added to the Session Time 56-4.

In the case of the user terminal with the user name “tanaka”, values of the statistics data in the PPP user management table are varied by the periodic updating so as to be, e.g., Session Time 56-4=“00:05:00”, Input Packets 56-5=“2250”, Output Packets 56-6=“2567”, Loss Packets 45-7=“100”, and Congestion Time 56-8=“30”.

The access server 4 periodically generates accounting request (interim-update) packets 302 as the accounting process interim request packets in accordance with the RADIUS protocol processing routine 55 and transmits the generated packets to the authentication/accounting server 21 (S10). The accounting request (interim-update) packet 302 includes the values of the statistics data shown by the PPP user management table 56.

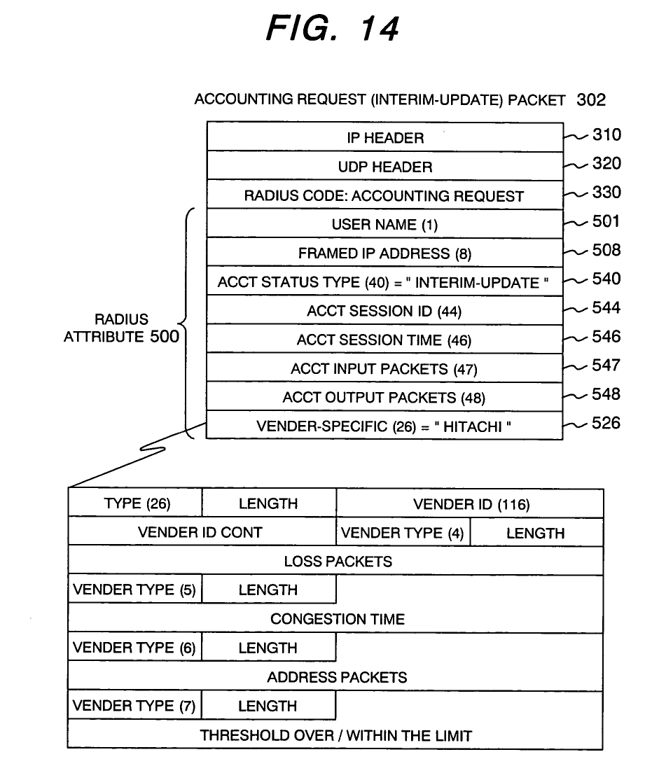

FIG. 14 shows the format of the accounting request (interim-update) packet 302. The accounting request (interim-update) packet 302 includes, as the attribute 500, the User-Name attribute 501 indicative of the user name, the Framed-IP-Address attribute 508 indicative of the IP address allocated to the user terminal, the Acct-Status-Type attribute 540 indicative of the type of an accounting process request packet, and an Acct-Session-ID attribute 504 indicative of a PPP session identifier, similarly to the accounting request (start) packet 301 shown in FIG. 13. A code “3” indicating that this packet is for interim accounting request (“interim-update”) is set to the Acct-Status-Type attribute 540.

In addition to the foregoing attributes, the accounting request (interim-update) packet 302 also includes an Acct-session-Time attribute 546 indicative of the time duration of a PPP session, Acct-Input-Packets attribute 547 indicative of the number of input packets, Acct-Output-Packets 548 indicative of the number of output packets, and the Vendor-Specific attribute 526. Besides the above attributes, the accounting request (interim-update) packets 302 includes, e.g., an Event-Timestamp attribute (555) indicative of the generation time of the accounting request (interim-update) packet 302, and the like, but they are not shown in the drawings.

In the case of the user terminal with the user name “tanaka”, statistics data including Loss Packets 56-7=“100” and Congestion Time 56-8=“30”, and the like, shown in the PPP user management table 56, are set as the Vendor-Specific attribute 526 in accordance with the Vendor Type definition shown in FIG. 11 in such a manner that, e.g., Vender Type (4)=100 and Vender Type (5)=30.

Upon receiving the accounting request (interim-update) packet 302 from the access server 4, as shown in FIG. 8 (S20), the authentication/accounting server 21 updates the values of the statistics data in the entry corresponding to User Name 501 in the accounting management database 211 in accordance with the contents of the Radius attribute 500 shown by the received packet, notifies the Web server 24 of the updated statistics data, and transmits a response packet (accounting response) to the access server 4 (S11).

The Web server 24 updates public parameter information in the database 231 in accordance with the statistics data (S21). Accordingly, the Internet user can view and acquire his parameter information in real time by accessing the Web server 24.

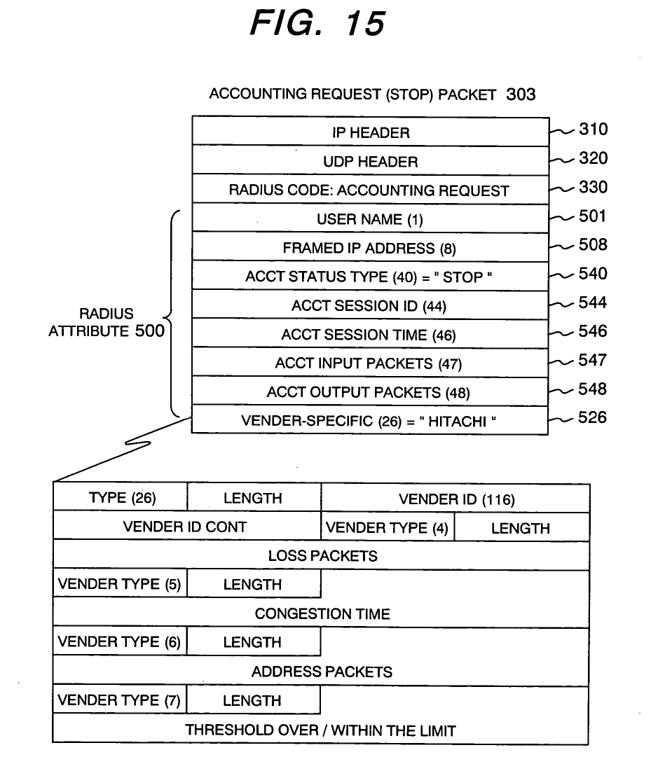

When the user of the user terminal 6 terminates the Internet session, an IPCP termination process (S12) an LCP termination process (S13), and a PPPoE session releasing process (S14) are executed between the user terminal 6 and the access server 4, as shown in FIG. 6. When the PPPoE session releasing process is completed, the access server 4 generates an accounting request (stop) packet 303 shown in FIG. 15 as the accounting process end request packet and transmits the generated packet to the authentication/accounting server 21 (S15).

The accounting request (stop) packet 303 has the same format as the accounting request (interim-update) packet 302 shown in FIG. 14. In the packet 303, a code “2” indicating that this packet is for ending the accounting process (“stop”) is set to the Acct-Status-Type attribute 540, while latest statistics data values in the PPP user management table 56 are set to the Radius attribute 500.

Upon receiving the accounting request (stop) packet 303, the authentication/accounting server 21 executes a final updating process of the statistics data (Step S20 in FIG. 8) and returns an accounting Response to the access server 4 (S16). At this time, the Web server 23 also executes the final process of updating the public parameter information (S20 in FIG. 8).

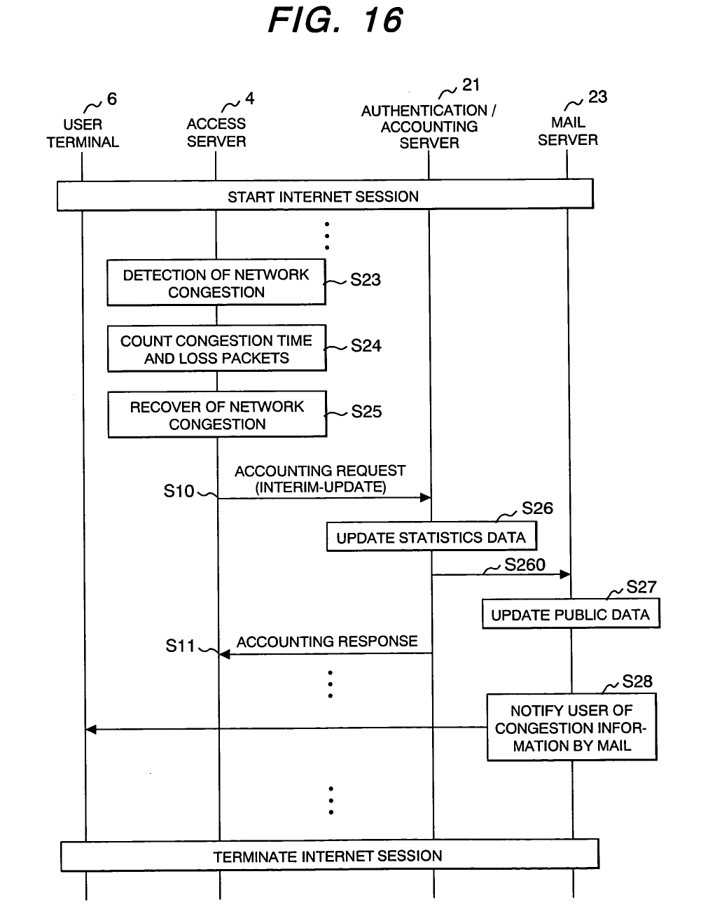

Referring to a sequence diagram in FIG. 16, a description will be given next to the operation of the accounting process when congestion on the network has caused packet loss and the Internet access service is temporarily interrupted.

Upon detecting the congestion on the network (S23), the access server 4 counts the values of parameters such as the congestion time and the number of loss packets for each user (session) in accordance with the statistics information collection conditions specified in the PPP user management table 56 and updates the statistics data in the PPP user management table 56 (S24). In the case where the user name is “tanaka” described above, e.g., the counting operation updates the values of the statistics data so as to be, e.g., Session Time 56-4=“00:05:30”, Input Packets 56-5=“2250”, Output Packets 56-6=“2567”, Loss Packets 45-7=“100”, and Congestion Time 56-8=“30”, as shown in FIG. 12.

Upon detecting recovery from the congestion on the network (S25), the access server 4 generates the accounting request (interim-update) packet 302 containing the Vendor-Specific attribute shown in FIG. 14 in accordance with the RADIUS protocol processing routine 55 and transmits the statistics data shown in the PPP user management table 56 to the authentication/accounting server 21 (S10). In the case where the user name is “tanaka”, e.g., the value of the Loss Packets 45-7 and the value of the Congestion Time 56-8 are reported as Vender Type (4)=“100” and Vender Type (5)=“30” to the authentication/accounting server 21, respectively.

Upon receiving the accounting request (interim-update) packet 302, the authentication/accounting server 21 updates the data of the entry indicated by the User Name 501 of the received packet in the accounting management database 211 in accordance with the contents of the Vendor-Specific attribute of the received packet (S26). Thereafter, the authentication/accounting server 21 notifies the mail server 23 of the User Name and the statistics data including the number of loss packets caused by the congestion and the service interruption time (S260), and transmits an accounting response packet serving as a response to the reception of the accounting request (interim-update) packet 302 to the access server 4 (S11).

The mail server 23 updates the database 231 in accordance with the contents of the notification from the authentication/accounting server 21 (S27) and then transmits the statistics information, which is congestion information in this example, to the mail address of the user (S28). According to the above sequence, the statistics information such as the number of loss packets, the service interruption time, and the like preliminarily specified by parameters can be delivered in real time to each of the Internet users.

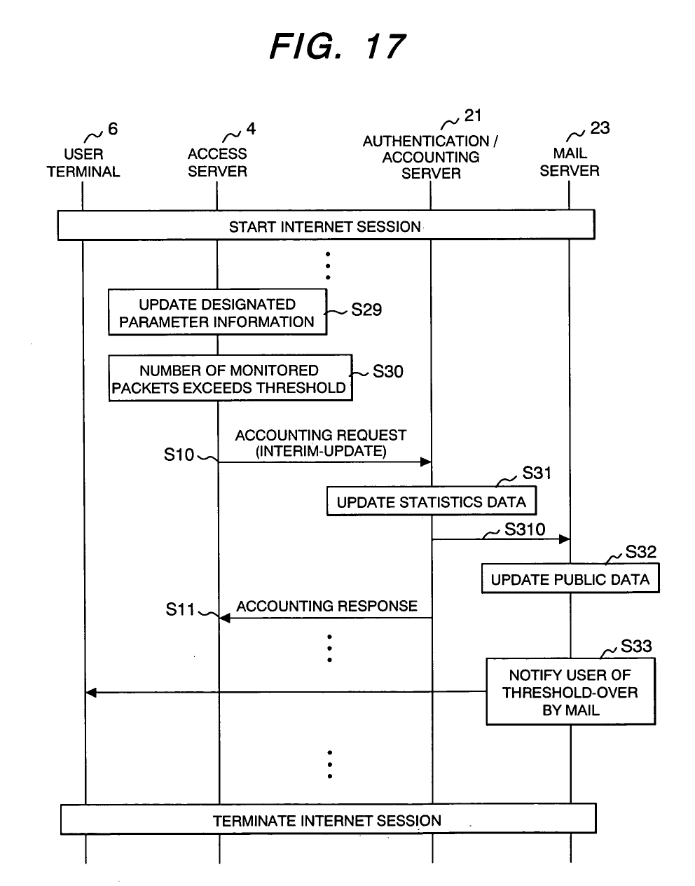

Referring to a sequence diagram shown in FIG. 17, a description will be given next to a statistics information public service specific to the present invention which monitors, e.g., an amount of packet communication transmitted from a specified IP address at the access server 4 and notifies, when the amount of packet communication exceeds a value preliminarily contracted with the user, the user of the exceeded value by electronic mail.

The access server 4 monitors the number of packets (amount of communication) transmitted from the specified IP address registered as the monitored address 56-9 in the PPP user management table 56 and counts the number of the packets as the number of monitored packets 56-10 (S29). The access server 4 compares the number of monitored packets with the preliminarily specified threshold 56-11 and, when the threshold is exceeded (S30), transmits the accounting request (interim-update) packet 302 indicative of the exceeded threshold to the authentication/accounting server 23 (S10). This accounting request (interim-update) packet 302 is different from the accounting request (interim-update) packet transmitted in Step S10 of FIG. 16 only in the Vendor-Specific attribute information.

For example, it is assumed that, as shown in the entry of the user name “yamada” in the accounting management database 211 of FIG. 9, the user “yamada” and the Internet service provider 2 have made a contract therebetween such that, when the number of packets transmitted from the monitored address 211-10 (“10.1.1.0/24”) to the terminal with the user name “yamada” exceeds “1000” specified as the threshold 211-12, notification of the exceeded threshold should be made by mail. In this case, when there is an Internet access request from the user terminal with the user name “yamada”, the authentication/accounting server 21 notifies the access server of the foregoing contract condition by specifying Vender Type (1)=“2”, Vender Type (2)=“10.1.1.0/24”, and Vender Type (3)=“1000” in the Vendor-Specific attribute 526 of the access request packet 300.

The access server 4 stores the contract conditions in the entry of the user name “yamada” in the PPP user management table 56 and executes the counting of the number of monitored packets 56-10 (S29) and the over-threshold judgment (S30). When the number of monitored packets of the user name “yamada” exceeds the threshold, the access server 4 generates, in accordance with the RADIUS protocol processing routine 55, the accounting request (interim-update) packet 302 in which, e.g., Vender Type (6)=“1001” and Vender Type (7)=“Over Set Value” are specified as the Vendor-Specific attribute and transmits the generated packet to the authentication/accounting server 21 (S10).

Upon receiving the accounting request (interim-update) packet 302, the authentication/accounting server 21 updates the statistics data in the entry of the user name “yamada” in the accounting management database 211 (S31). Thereafter, the authentication/accounting server 21 requests the mail server 23 to transmit a mail notifying that the number of monitored packets is exceeded to the mail address of the user name “yamada” (S310), and transmits an accounting response packet serving as a response to the reception of the accounting request (interim-update) packet 302 to the access server 4 (S11).

The mail server 23 updates the database 231 in accordance with the contents of the notification from the authentication/accounting server 21 (S32) and then transmits a mail notifying that the number of monitored packets is exceeded to the mail address of the specified user (S33). According to the above sequence, the Internet user can know in real time that the amount of packet communication from the IP address preliminarily specified is over the specified value.

Although the above embodiments have preliminarily designates the number of loss packets and the amount of packet communication from the specified IP address as different parameters showing contract conditions between the users and the Internet service provider, the type of statistics information to be collected in the monitoring service and a mode of designation are not limited to those shown in the foregoing embodiments and various modifications can be made thereto in such a manner that, e.g., a plurality of monitored IP addresses are designated or the number of loss packets is limited to that of packets from a specified IP address.

Although the embodiments have specified various kinds of parameter information based on the Vender Type in the Vendor-Specific attribute in the packet exchanged between the access server 4 and the authentication/accounting server 21, an attribute defined as reserved in the RFC 2866 may also be used.

1. A network statistics information service system, comprising of:
a service provider system having a database for storing, in correspondence with a user identifier, statistics data and statistics information collection conditions desired by a user; and
an access server for transmitting an authentication request packet to said service provider system upon receiving an authentication request from a user terminal via an access network, receiving from said service provider system a response packet indicating a result of authentication, an identifier of the request source user, the statistics information collection conditions, and statistic parameters to be collected, and responding to said user terminal based on the result of authentication indicated by the response packet, wherein
said access server is comprised of:
a management table for storing the statistics information collection conditions and the statistics parameters each indicated by the response packet from said service provider in correspondence with the user identifier and a session identifier;
statistics data updating means for collecting information in accordance with the statistics information collection conditions and the statistics parameters each indicated by said management table while said user terminal is connected to the Internet and updating statistics data in said management table; and
update request generating means for generating an update request packet indicating said updated statistics data and transmitting the generated update request packet to said service provider system, and
said service provider system updates the statistics data in said database based on the contents of the update request packet received from said access server and discloses, in response to a request from the user terminal, at least a part of the statistics data accumulated in said database in correspondence with the user identifier of the user terminal.

2. A network statistics information service system according to claim 1, wherein
said update request generating means transmits, to said service provider system, the update request packets periodically generated at specified intervals while the user terminal is connected to the Internet and the update request packet generated upon releasing of a session with said user terminal resulting from termination of the connection to the Internet.

3. A network statistics information service system according to claim 1, wherein
said service provider system is comprised of: a statistics information management server for managing said database and responding to the authentication request packet and the update request packet from said access server; and
a Web server for executing a process for disclosing the statistics data in response to the request from said user terminal.

4. A network statistics information service system according to claim 2, wherein
said service provider system is comprised of: a statistics information management server for managing said database and responding to the authentication request packet and the update request packet from said access server; and
a Web server for executing a process for disclosing the statistics data in response to the request from said user terminal.

5. A network statistics information service system according to claim 2, wherein
said update request generating means generates, upon occurrence of a specified event preliminarily specified by said statistics information collection conditions, an update request packet indicative of the occurrence of the specified event and transmits the generated update request packet to said service provider system.

6. A network statistics information service system according to claim 5, wherein
one of said statistics information collection conditions specifies a monitored IP address and a threshold, and
said access server counts the number of packets transmitted from said monitored IP address by said statistics data updating means and, when said number of packets exceeds said threshold, generates the update request packet indicative of the exceeded threshold and transmits the generated update request packet to said service provider system by said update request generating means.

7. A network statistics information service system according to claim 5, wherein
one of said statistics information collection conditions specifies counting of the number of loss packets, and
said access server counts the number of packets lost upon occurrence of network congestion by said statistics data updating means, and generates an update request packet indicative of said number of loss packets upon recovery from the congestion and transmits the generated update request packet to said service provider system by said update request generating means.

8. A network statistics information service system according to claim 5, wherein
one of said statistics information collection conditions specifies counting of a service interruption time, and
said access server counts the service interruption time resulting from network congestion by said statistics data updating means, and generates an update request packet indicative of said service interruption time upon recovery from the congestion and transmits the generated update request packet to said service provider system by said update request generating means.

9. A network statistics information service system according to claim 5, wherein said service provider system is comprised of:
a statistics information management server for managing said database and responding to the authentication request packet and the update request packet from said access server;
a Web server for executing a process for disclosing the statistics data in response to the request from said user terminal; and
a mail server for notifying, upon receipt of the update request packet resulting from occurrence of a specified event from said access server, a user terminal of concern of the occurrence of said specified event.

10. A network statistics information service system according to claim 6, wherein said service provider system is comprised of:
a statistics information management server for managing said database and responding to the authentication request packet and the update request packet from said access server;
a Web server for executing a process for disclosing the statistics data in response to the request from said user terminal; and
a mail server for notifying, upon receipt of the update request packet resulting from occurrence of a specified event from said access server, a user terminal of concern of the occurrence of said specified event.

11. A network statistics information service system according to claim 7, wherein said service provider system is comprised of:
a statistics information management server for managing said database and responding to the authentication request packet and the update request packet from said access server;
a Web server for executing a process for disclosing the statistics data in response to the request from said user terminal; and
a mail server for notifying, upon receipt of the update request packet resulting from occurrence of a specified event from said access server, a user terminal of concern of the occurrence of said specified event.

12. A network statistics information service system according to claim 8, wherein said service provider system is comprised of:
a statistics information management server for managing said database and responding to the authentication request packet and the update request packet from said access server;
a web server for executing a process for disclosing the statistics data in response to the request from said user terminal; and
a mail server for notifying, upon receipt of the update request packet resulting from occurrence of a specified event from said access server, a user terminal of concern of the occurrence of said specified event.

13. An Internet access server for transmitting an authorization request packet to a service provider system upon receiving an authorization request from a user terminal and responding to said user terminal, upon receiving from said service provider system a response packet indicative of a result of authentication, an identifier of the request source user, statistics information collection conditions and statistics parameters to be collected, based on the result of authentication indicated by the response packet, said access server comprising of:
a management table for storing the statistics information collection conditions and the statistics parameters each indicated by the response packet from said service provider system in correspondence with the user identifier and a session identifier;
statistics data updating means for collecting information in accordance with the statistics information collection conditions and the statistics parameters each indicated by said management table while said user terminal is connected to the Internet and updating statistics data in said management table; and
update request generating means for generating an update request packet indicative of said updated statistics data and transmitting the generated update request packet to said service provider system.

14. An Internet access server according to claim 13, wherein
said update request generating means transmits to said service provider system, the update request packets periodically generated at specified intervals while the user terminal is connected to the Internet and the update request packet generated upon releasing of a session with said user terminal resulting from termination of the connection to the Internet.
